(19) United States
(12) Patent Application Publication
(10) Pub. No.: US 2023/0228391 A1
(43) Pub. Date: Jul. 20, 2023

(54) Recessed Enclosure for a Light Source

(71) Applicant: Appleton Grp LLC, Rosemont, IL (US)

(72) Inventors: Prashant S. Dixit, Pune (IN); Ritu Raj, Muzaffarpur (IN); Rahul Bhamare, Nashik (IN)

(21) Appl. No.: 17/748,621

(22) Filed: May 19, 2022

(30) Foreign Application Priority Data
Jan. 20, 2022 (IN) 202221003346

(51) Int. Cl. F21S 8/02; F21V 31/00

(52) U.S. Cl. CPC F21S 8/026; F21V 31/005

(57) ABSTRACT

A recessed enclosure (100) for a light source (01). The recessed enclosure (100) includes a housing (102) having a mounting fixture for fitting a light source (01) thereon. A lid frame (104) has an opening (106) configured thereon emitting light from the light source (01). The lid frame (104) includes a first gasket (108) provided in a first groove (105), configured on the lid frame (102). A transparent body (110) is nested with the first gasket (108) for reflecting light emitted by the light source (01). Retainer clips (112) are provided along the longitudinal edges of the first groove (105) to compress and seal the first gasket (108) to prevent ingress of dust and moisture through the opening (106). Three fasteners (114) securely attach the lid frame (104) to the housing (102).

### FIELD

This application claims priority to Indian Application No. 202221003346 entitled “A Recessed Enclosure For A Light Source” filed on Jan. 20, 2022, the contents of which are hereby incorporated by reference in their entirety.

The present disclosure relates to the field of enclosures for light sources.

### DEFINITION

IP66: The term “IP66” in the description refers to Ingress Protection which is a set of codes and rules dictated for enclosures and casings for rating the degree of protection required against dust, water, intrusion, and accidental contact.

### BACKGROUND

The background information herein below relates to the present disclosure but is not necessarily prior art.

Enclosures for a recessed light source usually consist of a housing in which the luminaire is installed and a glass lid attached to the housing to emit the light. Conventionally, the lid is attached hingably to an edge of the housing. The hingeable attachment of the lid creates a gap between the lid and the housing. When such a luminaire enclosure is set up in an IP66 environment, the chances of dust and moisture entering the enclosure through the holes significantly increases. Over a due period of time, accumulation of dust and moisture inside the enclosure damages the light source. Further, in unfortunate situations, if the light source is installed in hazardous gas areas, the toxic gases after coming in contact with the heated light source tend to explode. Moreover, chances of water trickling into the housing increases significantly.

Additionally, at least four holes were punctured on the glass lid and the housing to enable fastening of screws thereon, which conversely added to the stress acting on the area surrounding the holes on the lid. If the stress on these areas increases, the glass becomes more prone to breakage.

There is therefore felt a need for an enclosure for the light source which alleviates the aforementioned drawbacks.

### OBJECTS

Some of the objects of the present disclosure, which at least one embodiment herein satisfies, are as follows:

An object of the present disclosure is to provide a recessed enclosure for a light source.

Another object of the present disclosure is to provide a recessed enclosure for a light source which is used in an IP66 environment by protecting the light source from dust and moisture ingress.

Yet another object of the present disclosure is to provide a recessed enclosure for a light source which ensures safety in operation of the light source with ease in installation.

Other objects and advantages of the present disclosure will be more apparent from the following description, which is not intended to limit the scope of the present disclosure.

### SUMMARY

The present disclosure envisages a recessed enclosure for a light source.

The recessed enclosure comprises a housing, a light source removably fitted on the mounting fixture, a lid frame, and three fasteners for securely attaching the lid frame to the housing.

The housing is defined by a body having a floor and side walls extending in an operative upward direction from the floor. The housing includes a mounting fixture formed on the floor. The lid frame is defined by a metal body having an operative inner surface, an operative outer surface, and an opening configured on an operative centre of the body for facilitating emission of light from the light source. The lid frame comprises a first groove configured on the operative inner surface, along the periphery of the opening. A first gasket is configured to be housed in the first groove. The first gasket has a crevice configured along the length of the first gasket. A transparent body is nested in the crevice for reflecting light, emitted by the light source, through the opening. A pair of retainer clips is provided along the longitudinal edges of the first groove. The retainer clips are configured to compress and seal the first gasket in the first groove to ensure prevention of ingress of dust and moisture inside the enclosure through the opening.

### BRIEF DESCRIPTION OF THE ACCOMPANYING DRAWINGS

A recessed enclosure, of the present disclosure, for a light source will now be described with the help of the accompanying drawings, in which:

FIG. 1 illustrates an isometric view of the enclosure of the present disclosure;

FIG. 2 illustrates a side view of the lid frame hingably mounted on the housing of FIG. 1;

FIG. 3A illustrates an isometric view of a lid frame of the enclosure of FIG. 1 with gaskets installed thereon;

FIG. 3B illustrates an isometric cut-cross sectional view of the lid frame of FIG. 3A;

FIG. 4A illustrates an isometric view of the lid frame of FIG. 1 without the gaskets installed thereon;

FIG. 4B illustrates an isometric cut-cross sectional view of the lid frame of FIG. 4A;

FIG. 5A illustrates an isometric view of the first gasket of FIG. 3A;

FIG. 5B illustrates a cross-sectional view of the first gasket of FIG. 5A;

FIG. 6 illustrates a front sectional view of the enclosure in its closed operative configuration;

FIG. 7A illustrates a top view of a housing of the enclosure of FIG. 1; and

FIG. 7B illustrates an isometric view of the housing of FIG. 7A.

### LIST OF REFERENCE NUMERALS

01 light source

100 enclosure

102 housing

104 lid frame

105 first groove

106 slot on the lid frame

108 first gasket

108a flange of the gasket

108b walls of the gasket

109 opening of the gasket

110 transparent body

112 retainer clip

113 flap

114 fastener

116 headboard

118 lip

120 pressure switch

125 indicator

127 second gasket

128 second groove

α angle of opening between the lid cover and the housing

### DETAILED DESCRIPTION

Embodiments, of the present disclosure, will now be described with reference to the accompanying drawings.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a”, “an” and “the” may be intended to include the plural forms as well, unless the context clearly suggests otherwise. The terms “comprises”, “comprising”, “including” and “having” are open ended transitional phrases and therefore specify the presence of stated features, elements, modules, units and/or components, but do not forbid the presence or addition of one or more other features, elements, components, and/or groups thereof.

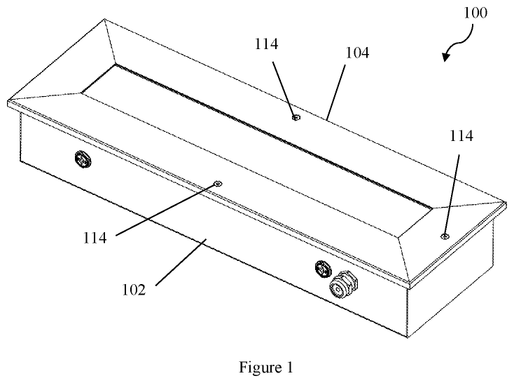

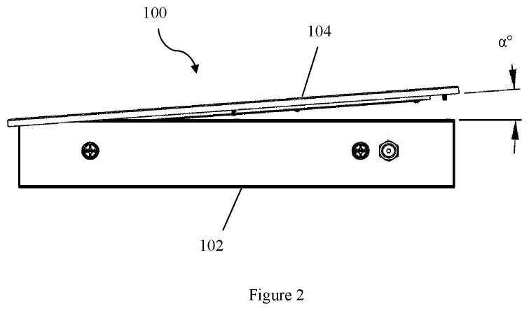

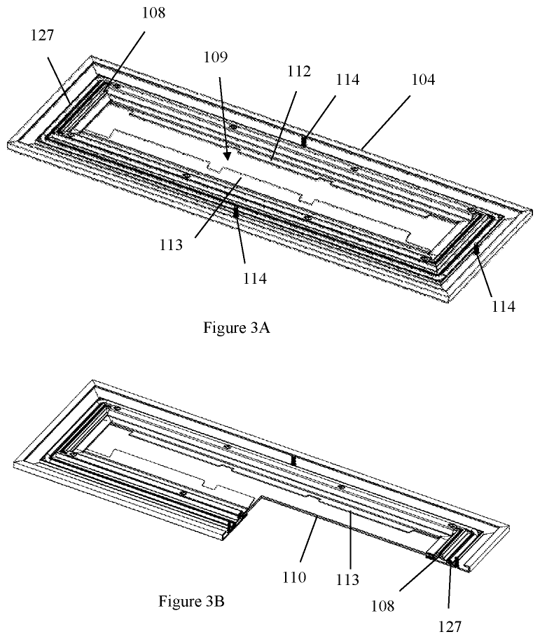

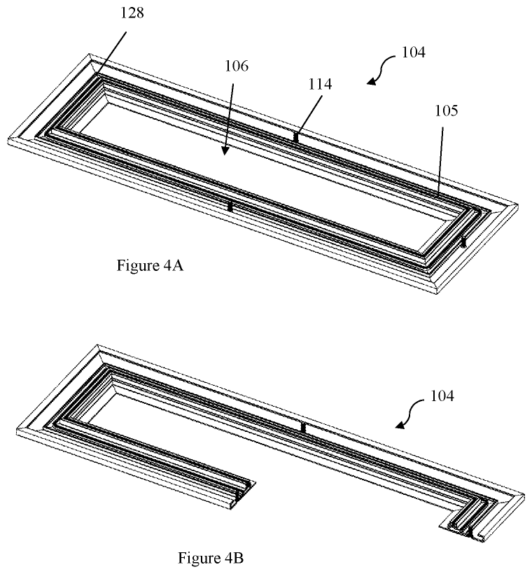

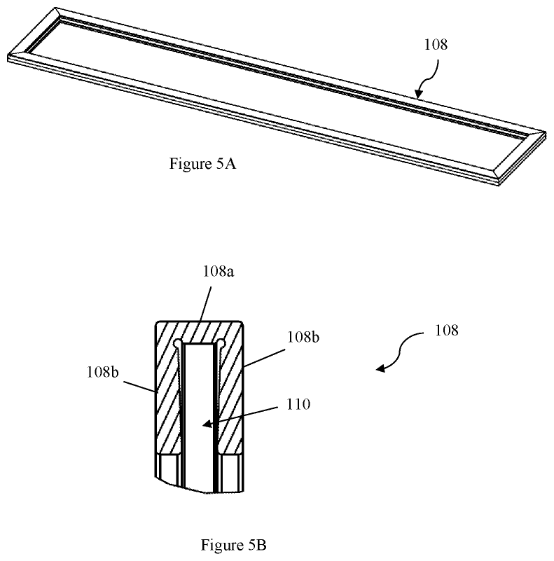

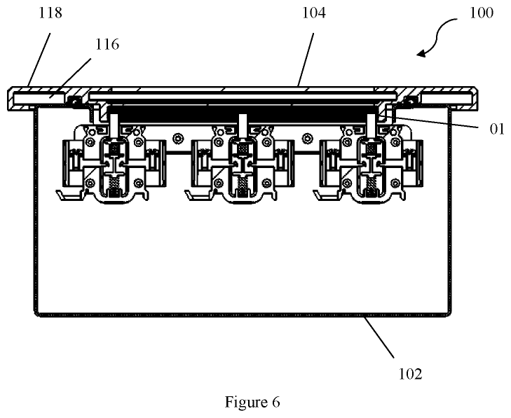

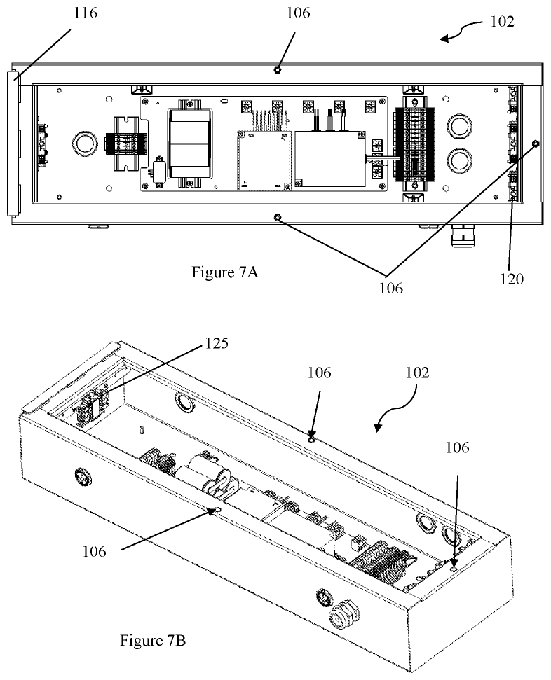

A recessed enclosure (100), of the present disclosure, for a light source (01) will now be described with reference to FIG. 1 through FIG. 7B.

The light source (01) is configured to be installed in an IP66 environment which mandates that no dust or moisture should permeate the enclosure (100). In an embodiment, the light source (01) is preferably an LED light source (01).

A recessed enclosure (100) comprises a housing (102), a light source (01) removably fitted in the housing, a lid frame (104), and three fasteners (114) for securely attaching the lid frame (104) to the housing (102). The housing (102) is defined by a body having a floor and side walls extending in an operative upward direction from the floor.

The housing (102) includes a mounting fixture formed on the floor. The mounting fixture is configured to allow the light fixture (01) to be fitted thereon. In an embodiment, the mounting fixture includes at least one pair of sockets for lockingly holding the light source (01) therein. The lid frame (104) is defined by a metal body having an operative inner surface, an operative outer surface, and an opening (106) configured on an operative centre of the body. The opening (106) facilitates emission of light from the light source (01).

The lid frame (104) comprises a first groove (105) configured on the operative inner surface, along the periphery of the opening (106). The lid frame further comprises a first gasket (108) configured to be housed in the first groove (105). The first gasket (108) has a crevice (109) configured along the length of the first gasket (108). A transparent body (110) is nested in the crevice (109) for reflecting light emitted by the light source (01) through the opening (106). A pair of retainer clips (112) is provided along the longitudinal edges of the first groove (105). The retainer clips (112) are configured to compress and seal the first gasket (108) in the first groove (105) to ensure prevention of ingress of dust and moisture inside the enclosure (100) through the opening (106), thereby satisfying the conditions required for the light source to work in an IP66 environment.

In an embodiment, the housing (102) includes an insulated layer secured to an operative central portion of the floor. The insulated layer helps in dissipating heat generated by the light source (01), and thus prevents overheating and possibly fire breakouts in the enclosure (100). In a preferred embodiment, the fixture is formed on the insulated layer.

In an embodiment, the body of the housing (102) includes rims extending outwards from the sidewalls in a direction perpendicular to the sidewalls. In another embodiment, the housing (102) further includes a plurality of first apertures. Each of the first apertures is configured on each of the longitudinal rims and a first lateral rim of the housing (102). In another embodiment, the lid frame (104) includes rims extending from the periphery of the body in an operative downward direction. The rims of the lid frame (104) are configured to envelop the rims of the housing (102) to close the enclosure (100). In another embodiment, the lid frame (104) includes a plurality of second apertures. Each of the second apertures is configured on each of the longitudinal rims and a first lateral rim of the lid frame (104), such that the second apertures are configured complementary to the first apertures. The first apertures and second apertures are configured to allow fasteners (114) to pass therethrough to facilitate attachment of the lid frame (104) with the housing (102).

Since only three fasteners (114) are used for the secure attachment of the lid frame (104) with the housing (102), the stress acting on the transparent body (110) or the lid frame body is considerably less. Further, the ingress of dust and moisture inside the enclosure (100) is completely prevented.

In an embodiment, the housing (102) includes a headboard (116) configured to extend from a second lateral rim of the housing (102). In another embodiment, the lid frame (104) includes a lip (118) extending from a second rim of the lid frame (104). The lip (118) is configured to be clamped on the headboard (116) to enable hingeable mounting of the lid frame (104) on the housing (102). The lid frame (104) is hingably mounted on the housing (102) with a predetermined relief angle (α) provided therebetween. In one embodiment, the predetermined relief angle ranges between 3° to 5°.

In a preferred embodiment, the lid frame (104) includes a second groove (128) configured on the operative inner surface of the lid frame (104). The second groove (128) is configured to complement the inner periphery defined by the sidewalls of the housing (102) in a closed configuration of the enclosure (100). In another embodiment, the lid frame (104) includes a second gasket (127) configured to be nested in the second groove (128). The second gasket (127) is configured to prevent ingress of dust and moisture inside the enclosure (100) through the rims of the housing (102) and the lid frame (104).

In an embodiment, the enclosure (100) includes a pressure switch (120) provided on the first lateral rim of the housing (102). The pressure switch (120) is connected to the light source (01). The pressure switch (120) is configured to be abutted by the second gasket (127) in a closed configuration of the enclosure (100). The pressure switch (120) is configured to be actuated on abutment of the second gasket (127) thereon to activate the light source (01). Conversely, if the pressure switch (120) is released say when the lid frame (10) is removed, the light source (01) is switched OFF. Thus, the pressure switch (1220) ensures that actuation of the light source (01) is handles in a safe way.

In an embodiment, each retainer clip (112) has a flap (113) extending therefrom and angularly bent at a predetermined angle away from the horizontal axis. The retainer clips (112) are attached to the lid frame (104) such that when the lid frame (112) is mounted on the housing (102), the flaps (113) are bent down towards the light source (01) to facilitate reflection of light emitted by the light source (01) outwards. In an embodiment, the flaps (113) are angularly bent from the body of the retainer clip (112) by a predetermined angle that ranges from 140° to 160°. In another embodiment, the flaps (113) are angularly bent from the body of the retainer clip (112) by a predetermined angle of 150°. In an embodiment, the flap (113) has an arcuate configuration. In another embodiment, the flap (113) has a planar configuration. In an embodiment, it is preferential that the retainer clips (112) are coloured white in order to increase the reflection of light. In an exemplary embodiment, it has been observed that the flaps (113) of the retainer clips (112) increase the reflection of light by at least 10% as against enclosures (100) for light sources (01) without any retainer clip (112).

In an embodiment, the retainer clip (112) is a Z-clip.

In an embodiment, the housing (102) is manufactured from stainless steel. In another embodiment, the lid frame (104) is manufactured from aluminum coated with MS powder.

In one embodiment, the housing (102) includes a plurality of niches configured on the side walls to nest a plurality of indicators (125) therein.

In a preferred embodiment, the first gasket (108) is a C-type gasket comprising a wall (108a) and flanges (108b) extending from either ends of the wall (108a) in a direction substantially perpendicular to the wall (108a) to define said crevice (109) between the operative free ends of the flanges (108b) for nesting the transparent body (110) therein. In one embodiment, the first gasket (108) is manufactured from silicon rubber, wherein the joints of the first gasket (108) are fused by vulcanizing the silicon rubber. In yet another embodiment, the flanges (108b) of the C-type gasket are separated with a predetermined distance ranging from 4.5 to 5 mm and at an angle ranging between 3° and 5°, preferably 4°.

In another embodiment, thickness of the first gasket (108) ranges between 2.2 mm and 2.8 mm. In a preferable embodiment, the thickness of the C-type gasket is 2.5 mm. In yet another embodiment, height of the first gasket (108) ranges between 8 mm and 11 mm. In a preferable embodiment, the height of the C-type gasket is 9.8 mm. In still another embodiment, the breadth of cross-section of the first gasket (108) ranges between 12 mm and 18 mm. In a preferable embodiment, the breadth of the cross-section of the C-type gasket is 15 mm. In still another embodiment, the edges of the first gasket (108) are filleted.

In an embodiment, the length of the lid frame (104) ranges between 665 mm and 660 mm. In another embodiment, the distance between the longitudinal edges of the opening (106) of the lid frame (104) ranges between 93 mm and 98 mm. In a preferable embodiment, the distance between the longitudinal edges of the opening (106) of the lid frame (104) is 95 mm.

In an embodiment, the distance between operative free edges of the flaps (113) in a mounted configuration of the retainer clips (112) ranges between 42 mm and 48 mm. In a preferable embodiment, the distance between the operative free edges of the flaps (113) in a mounted configuration of the retainer clips (112) is 45 mm.

In an exemplary embodiment, the enclosure (100), of the present disclosure, was tested by continuously spraying jets of water at a flow rate of 100 liters/min. After a time duration of 3 minutes, the spraying was stopped, zero moisture content was observed inside the enclosure (100). In another working embodiment, the enclosure (100) was tested by placing the enclosure (100) in a dust filled chamber at negative pressure of 20 millibar. After a time period of 8 hours, the enclosure (100) was taken out and, its exteriors were wiped thoroughly. When examined, it was observed that there was no dust content inside the enclosure (100).

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

Technical Advancements and Economic Significance

The present disclosure described herein above has several technical advantages including, but not limited to, the realization of a recessed enclosure for a light source, that:
is used in an IP66 environment by protecting the light source from dust and moisture ingress; and
ensures safety in operation of the light source with ease in installation.

The embodiments herein and the various features and advantageous details thereof are explained with reference to the non-limiting embodiments in the following description. Descriptions of well-known components and processing techniques are omitted so as to not unnecessarily obscure the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

We claim:

1. A recessed enclosure (100) for a light source (01) configured to be installed in an IP66 environment, said recessed enclosure (100) comprising:
a housing (102) defined by a body having a floor and side walls extending in an operative upward direction from said floor, said housing (102) including a mounting fixture formed on said floor;
a light source (01) removably fitted on said mounting fixture;
a lid frame (104) defined by a metal body having an operative inner surface, an operative outer surface, and an opening (106) configured on an operative centre of said body for facilitating emission of light from the light source (01), said lid frame (104) comprising:
a first groove (105) configured on said operative inner surface, along the periphery of said opening (106),
a first gasket (108) configured to be housed in said first groove (105), said first gasket (108) having a crevice (109) configured along the length of said first gasket (108),
a transparent body (110) nested in said crevice (109) for reflecting light, emitted by the light source (01), through said opening (106), and
a pair of retainer clips (112) provided along the longitudinal edges of said first groove (105), said retainer clips (112) configured to compress and seal said first gasket (108) in said first groove (105) to ensure prevention of ingress of dust and moisture inside said enclosure (100) through said opening (106); and
three fasteners (114) for securely attaching said lid frame (104) to said housing (102).

2. A recessed enclosure (100) as claimed in claim 1, wherein said housing (102) includes an insulated layer secured to an operative central portion of said floor for dissipating heat generated by said light source (01).

3. A recessed enclosure (100) as claimed in claim 2, wherein said fixture is formed on said insulated layer.

4. A recessed enclosure (100) as claimed in claim 1, wherein said body of said housing (102) includes rims extending outwardly from said sidewalls in a direction perpendicular to said sidewalls.

5. A recessed enclosure (100) as claimed in claim 4, wherein said housing (102) includes a plurality of first apertures, each of said first apertures is configured on each of the longitudinal rims and a first lateral rim of said housing (102).

6. A recessed enclosure (100) as claimed in claim 4, wherein said lid frame (104) includes rims extending from the periphery of said body in an operative downward direction, said rims configured to envelop said rims of said housing (102) to close said enclosure (100).

7. A recessed enclosure (100) as claimed in claim 6, wherein said lid frame (104) includes a plurality of second apertures, each of said second apertures is configured on each of the longitudinal rims and a first lateral rim of said lid frame (104) complementary to said first apertures.

8. A recessed enclosure (100) as claimed in claim 7, wherein said first apertures and second apertures are configured to allow fasteners (114) to pass therethrough to facilitate attachment of said lid frame (104) with said housing (102).

9. A recessed enclosure (100) as claimed in claim 1, wherein said housing (102) includes a headboard (116) configured to extend from a second lateral rim of said housing (102).

10. A recessed enclosure (100) as claimed in claim 9, wherein said lid frame (104) includes a lip (118) extending from a second rim of said lid frame (104), said lip (118) configured to be clamped on said headboard (116) to enable hingeable mounting of said lid frame (104) on said housing (102).

11. A recessed enclosure (100) as claimed in claim 1, wherein said lid frame (104) includes a second groove (128) configured on said operative inner surface of said lid frame (104), said second groove (128) being configured to complement the inner periphery defined by said sidewalls of said housing (102) in a closed configuration of said enclosure (100).

12. A recessed enclosure (100) as claimed in claim 11, wherein said lid frame (104) includes a second gasket (127) configured to be nested in said second groove (128) to prevent ingress of dust and moisture inside said enclosure (100) through said rims of said housing (102) and said lid frame (104).

13. A recessed enclosure (100) as claimed in claim 1, further including a pressure switch (120) provided on said first lateral rim of said housing (102), said pressure switch (120) being connected to said light source (01), said pressure switch (120) configured to be abutted by said second gasket (127) in a closed configuration of said enclosure (100), said pressure switch (120) further configured to be actuated on abutment of said second gasket (127) thereon and activate the light source (01).

14. A recessed enclosure (100) as claimed in claim 1, wherein each retainer clip (112) has a flap (113) extending therefrom and angularly bent at a predetermined angle away from the horizontal axis, said flap (113) configured to facilitate reflection light emitted by said light source (01) in a closed configuration of said lid frame (104).

15. A recessed enclosure (100) as claimed in claim 14, wherein said flap (113) has an arcuate configuration.

16. A recessed enclosure (100) as claimed in claim 14, wherein said flap (113) has a planar configuration.

17. A recessed enclosure (100) as claimed in claim 14, wherein said flap (113) is angularly bent away, from the horizontal axis, at a predetermined angle ranging between 140° and 160°.

18. A recessed enclosure (100) as claimed in claim 1, wherein said housing (102) comprises stainless steel.

19. A recessed enclosure (100) as claimed in claim 1, wherein said lid frame (104) comprises aluminum coated with MS powder.

20. A recessed enclosure (100) as claimed in claim 1, wherein said housing (102) includes a plurality of niches configured on said side walls to nest a plurality of indicators (125) therein.

21. A recessed enclosure (100) as claimed in claim 1, wherein said first gasket (108) is a C-type gasket comprising a wall (108a) and flanges (108b) extending from either ends of said wall (108a) in a direction substantially perpendicular to the wall (108a) to define a crevice (109) between the operative free ends of said flanges (108b) for nesting said transparent body (110) therein.

22. A recessed enclosure (100) as claimed in claim 21, wherein said first gasket (108) comprises silicone rubber.

23. A recessed enclosure (100) as claimed in claim 21, wherein a thickness of said first gasket (108) ranges between 2.2 mm and 2.8 mm.

24. A recessed enclosure (100) as claimed in claim 21, wherein a height of said first gasket (108) ranges between 8 mm and 11 mm.

25. A recessed enclosure (100) as claimed in claim 21, wherein a breadth of cross-section of said first gasket (108) ranges between 12 mm and 18 mm.

26. A recessed enclosure (100) as claimed in claim 1, wherein a length of said lid ranges between 660 mm and 665 mm.

27. A recessed enclosure (100) as claimed in claim 1, wherein a distance between the longitudinal edges of said opening (106) of said lid frame (104) ranges between 93 mm and 98 mm.

28. A recessed enclosure (100) as claimed in claim 14, wherein a distance between operative free edges of said flaps (113) in a mounted configuration of said retainer clips (112) ranges between 42 mm and 48 mm.
